(19) United States
(12) Patent Application Publication
(10) Pub. No.: US 2024/0027616 A1
(43) Pub. Date: Jan. 25, 2024

(54) DISTANCE INFORMATION ACQUISITION SYSTEM

(71) Applicant: Ningbo ABAX Sensing Electronic Technology Co., Ltd., Ningbo City (CN)

(72) Inventor: Shuyu LEI, Ningbo City, Zhejiang Province (CN)

(73) Assignees: Ningbo ABAX Sensing Electronic Technology Co., Ltd., Ningbo City, ZH (CN); Ningbo ABAX Sensing Electronic Technology Co., Ltd., Ningbo City, ZH (CN)

(21) Appl. No.: 18/038,764

(22) PCT Filed: Nov. 24, 2021
(86) PCT No.: PCT/CN2021/132686

§ 371 Date: May 25, 2023

(30) Foreign Application Priority Data
Nov. 27, 2020 (CN) 202011361142.2
Nov. 27, 2020 (CN) 202011361231.7

(51) Int. Cl. G01S 17/10; G01S 7/481

(52) U.S. Cl. CPC G01S 17/10; G01S 7/4816

(57) ABSTRACT

A distance information acquisition system, comprising: a light source module, a receiving module, and a processing module. The light source module comprises N groups of emitted lights having timing correlations, where N is an integer greater than or equal to 3, and at least two groups of adjacent emitted lights comprise timing correlations in terms of emission timing. The receiving module acquires a signal of returning lights in a field of view of the N groups of emitted lights outputted by the light source module and converts into an electric signal. The processing module acquires distance information of a detected object in one complete field of view on the basis of the electric signal converted from the N groups of emitted lights.

### CROSS REFERENCE TO RELATED APPLICATIONS

The present application claims priorities to Chinese Patent Application No. 202011361142.2, titled “A DISTANCE INFORMATION ACQUISITION SYSTEM”, and Chinese Patent Application No. 202011361231.7, titled “A DISTANCE INFORMATION ACQUISITION SYSTEM”, filed on Nov. 27, 2020 with the Chinese Patent Office, all of which are incorporated herein by reference in their entireties.

### FIELD

The present disclosure relates to the technical field of distance acquisition systems, and in particular to a DTOF type distance information acquisition system.

### BACKGROUND

In recent years, with the advancement of semiconductor technology, ranging modules miniaturization has progressed. For example, it has been achieved to install a ranging module in a mobile terminal such as a smartphone. With the advancement of science and technology, in the process of distance or depth information measurement, Time of Flight (TOF) is the commonly used method. The principle of the TOF is described as follows: A light pulse is continuously emitted to an object, and a light returned from the object is received by a sensor, and the distance to the object is obtained by detecting the flight (round-trip) time of the light pulse. The currently commonly used methods include a direct time-of-flight detection method and an indirect time-of-flight detection method. In the direct time-of-flight detection method, the distance to the object is obtained based on a direct time difference between the emission light and the return light. In the indirect time-of-flight (ITOF) detection method, the emitting light signal is periodically modulated, a phase difference between the emission light and the return light is obtained, a final flight time is obtained based on the phase difference, so as to calculate the distance to the object. ITOF includes continuous wave (Continuous Wave, CW) modulation-demodulation type and pulse modulation-demodulation type (Pulse Modulated, PM) according to the different modulation-demodulation types. DTOF technology obtains distance to the object directly by calculating the time difference between the emitting time and the reception time of the light pulse, DTOF technology has the advantages of simple principle, good signal-to-noise ratio, high sensitivity and high accuracy, and has received more and more attention.

The principle of the TOF is described as follows. The laser emitting source emits light pulse with a certain pulse width firstly, the pulse width can be a few nanoseconds, a receiving array module with the SPAD in the avalanche state receives the light pulse returned from the objects, wherein the detection unit in the avalanche state can receive the returned signal, the processing module can output the distance between the detecting system and the detected object through the processing by the processing module to complete the detecting. Tens of thousands of laser pulses can be emitted to obtain high-confidence results, the detection unit obtains a statistical result, a more accurate distance can be obtained by processing the statistical results. However, a large data processing requirement and a large number of time digital converter (TDC) modules will be introduced by multiple statistical results for each pixel in the ranging process. Then it is difficult to miniaturize the chip size and the processing speed or the frame rate of the entire field of view image will be very low, it is particularly disadvantageous to popularization and application of this solution. In a patent NO. CN111694007A (titled “A PIXEL ARRAY, A RECEIVING MODULE AND A DECTIONG SYSTEM”), a method for designing is proposed, which is implanted by a rectangular unit to adapt to the characteristics of the detected object in the market, cooperating with the light source in four (or three) sub-frames by implementing the different pixel types in the pixel unit, synthesizing the information of the whole field of view. Therefore, it is not only ensuring the miniaturization and high integration of the chip, but also obtain more complete information in the field of view. In addition, to ensure the receiving module has the higher absorption characteristics for the returned light to achieve more accurate statistical results, a patent NO. CN112162257A (titled “DETECTION METHOD AND DETECTION SYSTEM”), a method for calibrating in powering on time or in the fixed time period, or adaptive correction is proposed, which ensuring the emission light spot from the light source can be received in the maximum extent, so that the detection result of the detection system is always in the optimal condition. DTOF can be used in the accurate detection in the global field of view with the requirements of smaller size and larger integration by the above mentioned methods, and light source is designed in point array, the pinot array light source can be divided into N groups to achieve a higher resolution of the field of view, where the N an be 3, 4, 5, and so on. The entire field of view detection information is formed by the combination of the returned light from the object in the field of view, the returned light is the emitting light of the N groups point array light source in returned by the object in the field of view.

However, in the use process, the data amount of that the DTOF array needs to read out is also a lot, which restricts the application of the DTOF system in the high frame rate, such as higher than 30 FPS (Frames Per Second, the number of frames transmitted per second). Therefore, it is an urgent problem to be solved how to design a detection system and control scheme that can achieve the requirements of higher integration and miniaturization under the premise of maintaining the advantages of the existing design.

### SUMMARY

A distance information acquisition system is provided in the present disclosure, which can improve the ability of the distance information acquisition system, especially the statistical DTOF scheme, to adapt the design of the transmitter to achieve high resolution in the field of view, to achieve high-speed and accurate distance measurement results, and other scenarios, in the development requirements of high integration and chip miniaturization.

Technical solutions in embodiments of the present disclosure are provided as follows.

A distance information acquisition system is provided according to an embodiment of the present disclosure. The distance information acquisition system is performed by an information acquisition system including a light source module, a receiving module and a processing module. The light source module includes N groups of emission light, where N groups of emission light are timing correlation and N is an integer greater than or equal to 3, at least two groups of adjacent emission light are timing correlation in emission timing. The receiving module receives the returned light of N groups of emission light in the field of view and converts the returned light signal into electrical signal, where the N groups of emission light are emitted by the light source module. The processing module obtains a set of distance information of the detected object in complete field of view according to the electrical signals converted by the N groups of emission light.

In an embodiment, the N groups of emission light are at least divided into M emitting types of light, where M is an integer greater than or equal to 2, wherein there are at least 2 groups of emission light in at least one type of light, the at least 2 groups of emission light includes a first timing correlation in emission timing, the M emitting types of light include a second timing correlation in emission timing.

In an embodiment, the N is 4 of the N groups of emission light with timing correlation.

In one embodiment, the light emission time interval of the first timing correlation is less than or equal to the light emission time interval of the second timing correlation.

In one embodiment, the light emission time interval of the first timing correlation further includes a quench time interval where the quench time interval is not more than 20% of the minimum duration of the N groups of emission light.

In an embodiment, the N groups of emission light with time correlation are all emission light spot clusters, where each spot cluster includes the same number of multiple discontinuous light spots.

In one embodiment, the receiving module includes SPAD array module.

In an embodiment, the processing module obtains at least two different time windows widths statistical results according to at least one group of emission light conversion signals output by the SPAD array module.

In an embodiment, the processing module obtains the distance result information of the detected object in the field of view according to the at least two different time windows widths statistical results of the at least one group of emission light conversion signals.

In an embodiment, the distance information acquisition system acquires not less than 30 groups distance information of the detected objects in a complete field of view, during at least part of the working time.

In one embodiment, at least two groups of emission light of at least one emitting type further include a third timing correlation in the emission timing.

In one embodiment, the light emission time interval of the third timing correlation is less than the light emission time interval of the first timing correlation.

### The Beneficial Effect of this Discourse is

According to the distance information acquisition system provided in the embodiment of the present disclosure, the distance information acquisition system is performed by an information acquisition system including a light source module, a receiving module and a processing module. The light source module includes N groups of emission light, the N groups of emission light are at least divided into M emitting types of light, where N is an integer greater than or equal to 3 and M is an integer greater than or equal to 2, wherein there are at least 2 groups of emitting light in at least one type of light, the at least 2 groups of emitting light includes a first timing correlation in emission timing, the M emitting types of light include a second timing correlation in emission timing. The receiving module receives the returned light of N groups of emission light in the field of view and converts the returned light signal into electrical signal, where the N groups of emission light are emitted by the light source module. The processing module obtains a set of distance information of the detected object in complete field of view by the N groups of converted electrical signal. Not only the problem of high-voltage design due to detection distance requirements and device driving in miniaturized devices but also the problem of the subsequent processing circuit will be workload in high-resolution when designing only one group of emission light can be solved by dividing the distance information in the whole field of view into the information of N groups of returned light, then the high resolution of the entire field of view and small amount of circuit data processing can be achieved. N groups of emitting light are designed into M emitting type, and different timing correlations are set within each emitting type and between the emitting types, which can achieve the requirements of maintaining high resolution and simple circuit design to obtain higher data processing effects, and provide a higher frame rate for the entire system to output the distance information of the field of view.

### BRIEF DESCRIPTION OF THE DRAWINGS

In order to illustrate technical solutions of embodiments of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic diagram showing time sequence of the operation of a corresponding pixel unit driving circuit according to an embodiment of the present disclosure;

FIG. 2 is a schematic diagram showing unitized detection array designed to adapt to the characteristics of the detected object in the field of view according to an embodiment of the present disclosure;

FIG. 3 is a schematic diagram showing an exemplary light source group emission according to an embodiment of the present disclosure;

FIG. 4 is a schematic diagram showing a working sequence control of a prior art system according to an embodiment of the present disclosure;

FIG. 5 is a diagram showing system operation sequence control according to an embodiment of the present disclosure;

FIG. 6 is a diagram showing the detailed exploded view of a system operation sequence control according to an embodiment of the present disclosure;

FIG. 7 is diagram showing another detailed exploded view of a system operation sequence control according to an embodiment of the present disclosure;

FIG. 8 is diagram showing another detailed exploded view of a system operation sequence control of the according to an embodiment of the present disclosure;

FIG. 9 is a schematic diagram showing storage design under a coarse, medium and fine time window design according to an embodiment of the present disclosure.

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those skilled in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

In DTOF ranging, since the pixel unit of the array sensor is a single-photon avalanche photodiode (SPAD) device, it works in the Geiger mode. In the Geiger mode, the SPAD absorbs photons to generate electron-hole pairs, which are accelerated by the strong electric field generated by the high reverse bias voltage to obtain sufficient energy, and then collide with the lattice to form The chain effect, resulting in the formation of a large number of electron-hole pairs, triggers the avalanche phenomenon, and the current increases exponentially. At this time, the gain of the SPAD is theoretically infinite, and a single photon can saturate the photocurrent of the SPAD, so the SPAD becomes the first choice for high-performance single-photon detection systems.

The principle of ranging is described as follows. The laser emitting source emits light pulse with a certain pulse width, the pulse width can be a few nanoseconds, a receiving array module with the SPAD in the avalanche state receives the light pulse returned from the objects, wherein the detection unit in the avalanche state can receive the returned signal, the processing module can output the distance between the detecting system and the detected object through the processing by the processing module. Tens of thousands of laser pulses can be emitted to obtain high-confidence results, the detection unit obtains a statistical result, a more accurate distance can be obtained by processing the statistical results. In the present disclosure, the light source can emit sheet detection light or can emit spot detection light, the light source module is implemented by a Vertical-Cavity Surface-Emitting Laser (VCSEL) or other similar light source modules, which are not limited here.

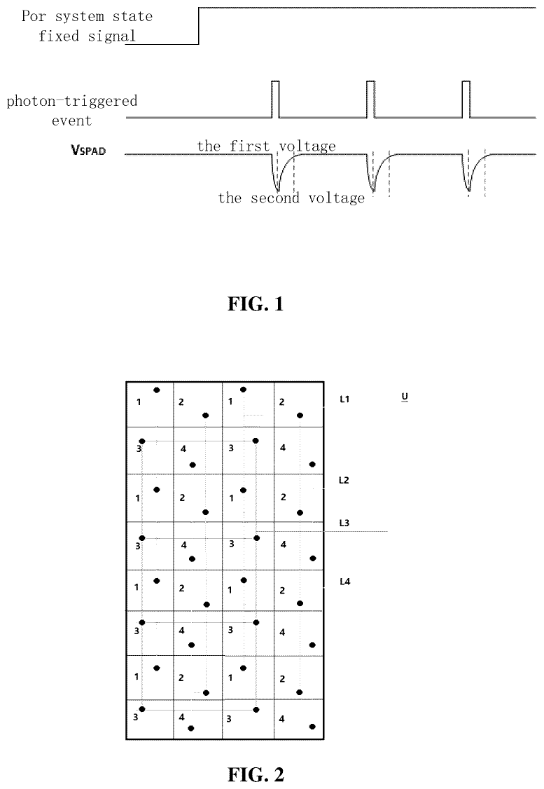

FIG. 1 is a schematic diagram showing time sequence of the operation of a corresponding pixel unit driving circuit according to an embodiment of the present disclosure. The SPAD connects to the first driving voltage through the first driving transistor MP1 to ensure the detection system has a definite initial state, a Por system state fixed signal works to control the photodiode has a determinate initial state, when the system is powered on. The maintenance of the initial state makes the state of the selected unit of the detector consistent during operation, and there is no need to worry about the interference of historical signals in used, on the other hand, the pixel unit can be quickly set to the working voltage mode and put into the working state. It is necessary to make the first driving voltage higher than the avalanche threshold voltage of the SPAD to realize the SPAD in the avalanche state, for example, when the SPAD avalanche threshold voltage is 20V, the first driving voltage here can be 2V-5V higher than the avalanche threshold voltage, to ensure each avalanche diode can be excited by the first driving voltage to reach the avalanche state, and the specific value is not limited here. For example, the first driving voltage can be 23V, the working unit has been applied with a driving voltage of 23V in the initial detection, and the voltage across the avalanche diode reaches 23V, which is higher than the threshold voltage, then the SPAD unit is in the avalanche state, when the photon-triggered event showing in FIG. 1 is fed back to the photodiode, the SPAD is triggered to sense the return trigger information of the photon, but when the SPAD unit is triggered it is necessary to be quickly quenched, that is, the voltage across the SPAD unit needs to be pulled down to avoid continuous avalanche, the second voltage value, for example, a voltage of 18V can be output to the second end of the SPAD, the voltage of the avalanche diode is forcibly pulled down then the entire avalanche state can be stopped in time. The lowest voltage which can trigger the avalanche state is the second voltage, showing as the process in which the voltage caused by the photon-triggered event is reduced from the highest first driving voltage to the second voltage in the timing diagram of FIG. 1. When the voltage across the SPAD unit drops to the second voltage or is slightly higher than the second voltage, it can be exemplarily selected to be 18.5V, that is, 0.5V higher than the second voltage, which is not limited here, but the value must be less than the threshold voltage of 20V and greater than the second voltage. When the second terminal of the SPAD is connected to the driving voltage through the recovery module, the voltage across the SPAD unit can be quickly pulled back to the first voltage from the second voltage, so as to quickly restore to the state that can be triggered, then completing an information detection of a photon-triggered event and output a detection event which the voltage is lowered and then raised. Detection can be performed again when the voltage across the SPAD unit recovers to the first voltage, then can continuously acquire the single-photon events, Of course, the reverse bias voltage higher than the threshold voltage can be achieved by applying a high negative voltage to the anode of the diode, here is not limited to a specific implementation.

To achieve the requirements of high detection efficiency and small data processing under the premise of chip miniaturization and high integration, FIG. 2 is a schematic diagram showing unitized detection array designed to adapt to the characteristics of the detected object in the field of view according to an embodiment of the present disclosure, as shown in FIG. 2 the simplicity and achievability of the post-processing circuit are ensured. As the schematic diagram shown in FIG. 2, only part of the pixels of each unit can be in working state at a certain time, then the light source needs to be designed accordingly, the light source is designed as a discontinuous spot structure. To ensure the acquisition efficiency of the returned light from the detected object in the field of the view is the highest, the spot size need to achieve the certain requirements, then the requirements of the amount of post-processing data can be achieved. When the light source is discontinuous spot, the resolution in the field of view will inevitably decrease, however at the light source end a smaller driving power is needed, so that the transmitter end will be more suitable for the reliability requirements under miniaturization and high integration.

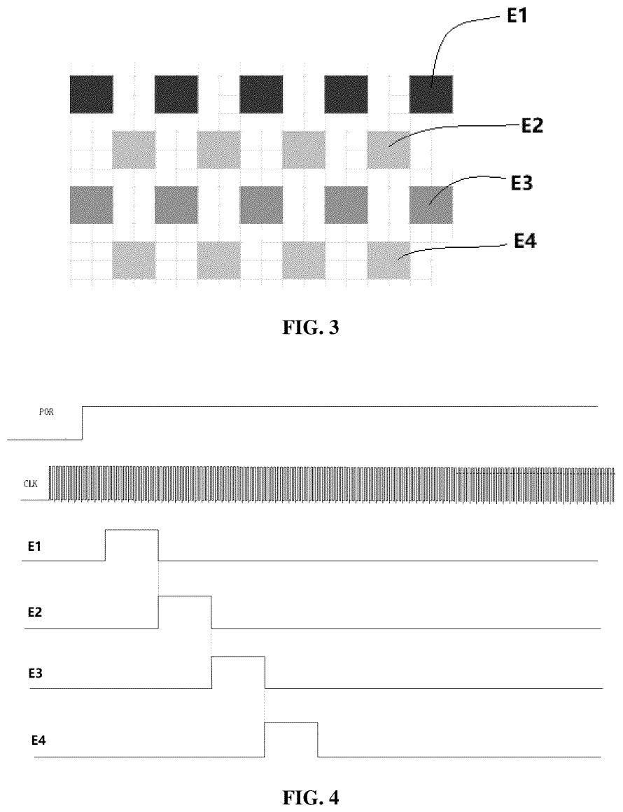

FIG. 3 is a schematic diagram showing an exemplary light source emission, as the schematic diagram shown the emission light group N is 4, here is not limited to only 4 groups of emission light, and of course, it can also be 3 groups, 5 groups, and so on. To obtain the higher resolution in the field of view, the number N of emission light groups needs to be an integer greater than or equal to 3. E1, E2, E3 and E4 in the FIG. 3 are four groups of emission light, and the emission light array is not limited to the specific number, the number of emission light in each group is optimally selected as an equal number, which can make the post-processing synthetic data information more reliable, and can adapt to more complex back-end processing algorithm design, for example the smooth derivation processing or similar edge information processing, etc. for the similar adjacent results, the four groups of emission light are all composed of discontinuous light spots (or called light spots). E1 as an example to illustrate, the emit optical power of E1 is ¼ of the entire designing in fact, because the resolution of the entire field of view is divided into four sub-sequences, then the required driving power is also very small to drive a group of E1 light sources, which ensures the reliability of the system and the distance ranging scope achieving the requirements, for example, a group of emission light can include 700 light spots, Of course, the actual light spots number should be determined according to the actual field of view and the farthest distance can be detected, etc., and here is only an exemplary description. The distance interval of each actual emission light spot can be limited to a very small scale through the arrangement of the four groups of emission light, thus ensuring that the detected object in the field of view will not be missed, for example control the distance interval at mm level within a range of 5 m, and the detection accuracy also satisfies a large number of usage scenarios. Of course, this effect is also an exemplary illustration and is not limited here.

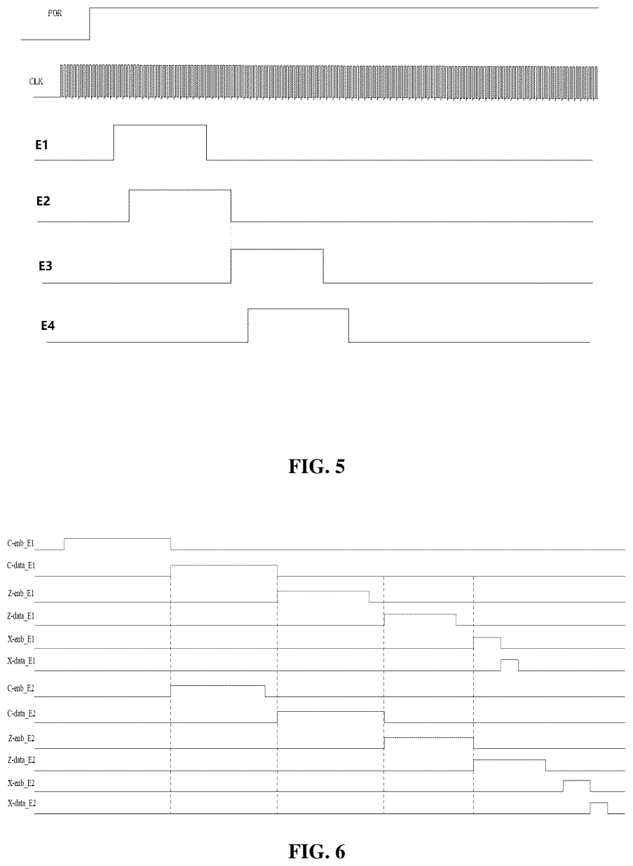

FIG. 4 is a schematic diagram showing a working sequence control of a prior art system, the processing process of different emission light groups E1, E2, E3 and E4 is a serial trigger process in the prior art mode, that is receiving end of the E1 emission light receive the returned light and then the processing circuit finishes processing, the statistical information associated with the detected object in the field of view is obtained, after the mentioned process the emission light group of E2 is emitted, then the entire emission cycle is completed. A particular design as the illustrative description is described as follows, here is not limited, to ensure the detection accuracy, for example, the actual resolution required is particularly high when need to identify contour features such as eyes, nose, etc., for example the resolution is mm level but at the same time, it is necessary to ensure that the detection scope is relatively far. For example, it is 5 m. It is necessary to separate a huge amount of time windows within the detection distance scope if the direct statistical method is used, the method is problematic, the method of using a coarse time window compatible with a fine time window is an optimized solution. Arrangement in time sequence of optimal solution of coarse time window, medium time window and fine time window is shown as an exemplary in the present disclosure. To obtain a more accurate positioning result, the coarse time window transmit pulse can be times, such as 60,000 or 70,000 times, which is not limited here. For example, the range of a special detected object is 3.253 m within a range scope of 5 m, in the coarse time window, for example, the range of the detected object can be obtained at 3.1-3.3 m, in order to further locate the position of the detected object, the light source emits tens of thousands of pulses, such as 60,000 to 70,000 times or more, then the detected object can be located within the range of 0.14-0.16 m through the mentioned first method, the distance of detected object can be located within the range of 3.24-3.26 m through the first result and the second result, Further making the time window more denser, the distance of detected object can be located within the range of 0.013-0.014 m, the final distance of the detected object is within the range of 3.253-3.254 m, of course, the other method is to superimpose the first result and the second result directly to obtain the result of the middle time window, the final distance of detected object is only obtained by superimposing the statistical results of the last remaining fine time window, which is not limited here, then the actual time required for each group of emission light can be obtained, for example, the total time spent emitting light for each group in an ideal situation can be obtained by the inventor. Therefore, it takes about 52.25 ms to complete the lighting and data transmission of the four types of light. the number of distances of all detected objects in the entire field of view that can be completed per second is 19, however, many scenes of practical application are designed according to the standard of the human eye, to achieve the assistance and adaptability of the developed tools to people at a minimum, but in fact, the number of visible frames per second when the human eye is comfortable and relaxed is 24 fps, no more than 30 fps when concentrating. The number of frames that can be captured at the moment of opening the eyes when blinking is more than 30 frames, that is, once a tool does not achieve the resolution standard of the human eye for the field of view, serious consequences may occur, such as, the recognition rate of tools is not as high as that of humans, which is more likely to cause accidents when applying the tool in a car, On the mobile phone, it is more likely that the information obtained cannot achieve the requirements of the human eye, which affects the use of users and causes design failure. Therefore, in the solution of the prior art completely unable to meet the requirements.

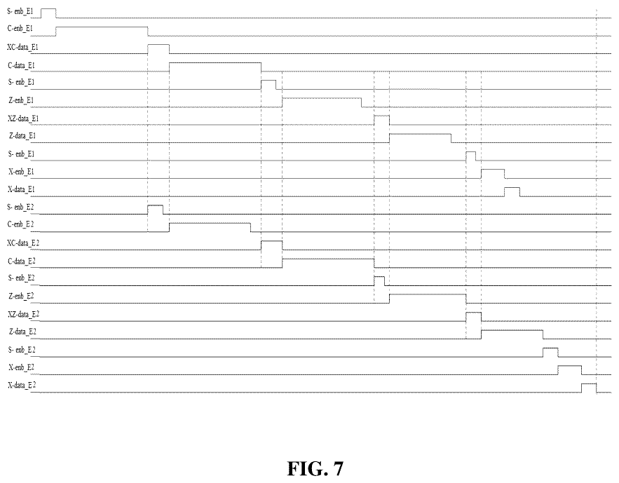

FIG. 5 is a diagram showing system operation sequence control according to an embodiment of the present disclosure. As mentioned methods previously, although multiple groups of lighting achieve the requirements of the detection distance and resolution in the field of view, and can also achieve the requirements of miniaturization and integration of the system, but the methods mentioned previously cannot achieve the requirements for equipment safety and utility. As the previous analysis, the main problem lies in the serial working mechanism of the equipment, but due to the requirements of equipment integration and data volume, it is necessary to design a modular unit at the receiving end, then the four groups E1, E2, E3, and E4 need to be shared between the detectors and the arrays, there will be a conflict of requirements, that is, part of the design requires serialization, but some requirements require the work cannot be serialized. In this contradictory scenario, the splitting thinking is introduced in the present disclosure, that is, the detection system and the processing circuit are actually separable, so this scenario occurs, the detector module only supports serialization, so the light source design must be serial emitting, that is, the emitting timing of E1, E2, E3 and E4 can only be operated in series, but the processing circuit can actually operate in parallel, for example, the emitting group N is divided into M emitting types, the data processing and data transmission are overlap in every emitting type, thus occurring a first time interval between emission light groups within each emitting type, and there is second time interval between emission light of different emitting types, different emission light groups can be included in each emitting type of M emitting types, for example, 4 groups of emitting light are divided into 2 emitting type, one emitting type includes 3 emitting groups and the other emitting type includes 1 emitting group, of course, the N emitting groups may be equally divided into the M emitting type, and the specific implementation scheme is not limited here.

FIG. 6 is a diagram showing the detailed exploded view of a system operation sequence control according to an embodiment of the present disclosure, two emitting groups in one emission type is expanded in FIG. 6, It can be clearly seen from FIG. 6 that the serial operation of the emitting light and the parallel operation of the processing circuit (based on the high-resolution scheme of the coarse, medium, and fine time windows associated with time, actually can only include two or more different time windows, which is not limited here), where C-enb_E1 is the emission time for starting to emit the coarse time window to obtain statistical results, the E1 emitting light group continues to emit for a period of time to achieve a predetermined number of pulsed laser emitting, E2 is emitted after the first time interval from E1 emitting pulse laser, E2 emitting light group continues for a predetermined time, the number of pulse laser emitted with E2 emitting light group for a predetermined number of times has been completed, the emitting light time of the two emitting light groups has a first timing correlation, and the two emitting light groups are not overlap in the emitting time, that is mentioned previously the receiving end is divided and receives serially, but data processing can be performed in parallel. Arrange at least partially overlapping C-data_E1 in the coarse time window emitting light sequence of C-enb_E2, that is, transmit the statistical results of the coarse time window of E1, the histogram operation and transmission timing in the present disclosure are also serialized to avoid increasing the number of storage units and operation units, Z-enb-E1 is activated when the e longer one of C-data_E1 and C-enb_E2 finishing, the E1 emitting group emits a predetermined amount of emission light, and the statistics of the middle time window are carried out, of course, the emission light duration of the middle time window can be the same as the emission light duration of the coarse time window, which can guarantee the calculation and the processing efficiently and ensure the accuracy of positioning, so Z-enb_E2 that is the emission light of the middle time window of the E2 emitting light group, also has the same first timing correlation with the coarse time window, the arrangement of data transmission timing of the middle time window is similar to the coarse time window, which will not be described in detail here. In order to obtain more accurate detection results, it is necessary to implement the fine time window, however, in order to ensure the efficiency of the ranging system, the duration of the emitting light in the fine time window should be optimal less than the duration of the coarse and/or medium time window, that is the number of pulses emitted in the fine time window is also small. Then under this design idea, X-enb_E1 can be arranged to start at any time during the duration of Z-data_E2, optimally it is included in the time duration of Z-data_E2, further there is a third time interval between the emission light in fine time window (that is, between X-enb_E1 and X-enb_E2), that is, the third timing correlation within the light group, optimally, the time interval of the third timing correlation is smaller than the time interval of the first timing correlation, this design can ensure the efficient utilization of the entire processing circuit, and there is no increase in space. The symbols in FIG. 6 is explained as follows: C-enb_E1 (emit E1 emission light for coarse time window statistics), C-data_E1 (transmit E1 emitting light group coarse time window statistics), Z-enb_E1 (emit E1 emission light to do middle time window statistics), C-data_E1 (transmit E1 emitting light group in time window statistics), X-enb_E1 (emit E1 emission light to do fine time window statistics), C-data_E1 (transmit E1 emitting light Group detailed time window statistics), the symbols of the E2 emitting group is similar, and will not be described in detail here. After completing the timing correlation arrangement of the two emitting groups in one type, a second timing correlation is established between the M emitting types, the emitting group of the second emitting type that emits light firstly starts to emit laser at the time after the second time interval from the first emission of the first emitting type, and the timing association of the remaining types starts until all distance detection result in the field of view corresponding to the N lighting groups emission light are obtained, that is, the emitting type actually work in series, but because the number of emitting groups N is reduced to the number of emitting type M, and alternate design with serial timing and parallel timing is used in the emitting types through the division idea, realizing the feasibility of improving the frame rate of the detection results of the whole system, the distance information of the detected objects in a complete field of view can be obtained by the electrical signals converted by N groups of emitting light, then the distance result information with high resolution in a frame of the detection system can be achieved, of course, the time interval of the second timing correlation needs to be larger than the time interval of the first timing series correlation.

FIG. 7 is diagram showing another detailed exploded view of a system operation sequence control according to an embodiment of the present disclosure, he same parts as shown in FIG. 6 will not be repeated in detail, and the functions are also similar, the selection control sequence is further included before the emission activation time sequence of each emitting group EX, a period of quench time interval is needed after the emission of each group of light emitting groups EX, the quench time interval can ensure that the information obtained in different time windows can be quickly transmitted, in order to ensure the efficiency of the system, the selection sequence of the two emitting light groups E1 and E2 in the emitting type is optimally include the quench time interval, and in order to achieve the optimal design of the system frame rate improvement, the quench time interval is optimally designed to not exceed 20% of the minimum lighting duration. In FIG. 7, S-enb_E1 is the light-emitting selection timing signal of E1, XC-data_E1 is the time interval of E1 quenching after the coarse time window and the transmission time of the TDC statistical information of the coarse time window, and XZ-data_E1 is time interval of E1 quenching after the middle time window and the transmission time of the TDC statistics information of the middle time window, the similar symbols of the E2 emitting light group is similar to the E1 emitting light group, and will not be described in detail here. The entire consumption time is 16.625 ms in one emitting type through the mentioned design, the total time required to complete a set of distance information results in a complete field of view is 33.25 ms, therefor a frame rate higher than 30 FPS can be achieved per second, that is, 30 sets of complete field-of-view detected distance information per second can be achieved, therefore, the solution of the present disclosure can meet the frame rate standard of the human eye under high concentration, and can ensure the reliability and safety of system applications tec., of course, the optimal case is all N emitting light groups can be designed according to the same timing correlation, so it is necessary to increase part of the hardware storage to meet the needs of more emitting light groups in the design of more overlapping timing sequences to ensure data transmission processing reliability, which will not be described in detail here.

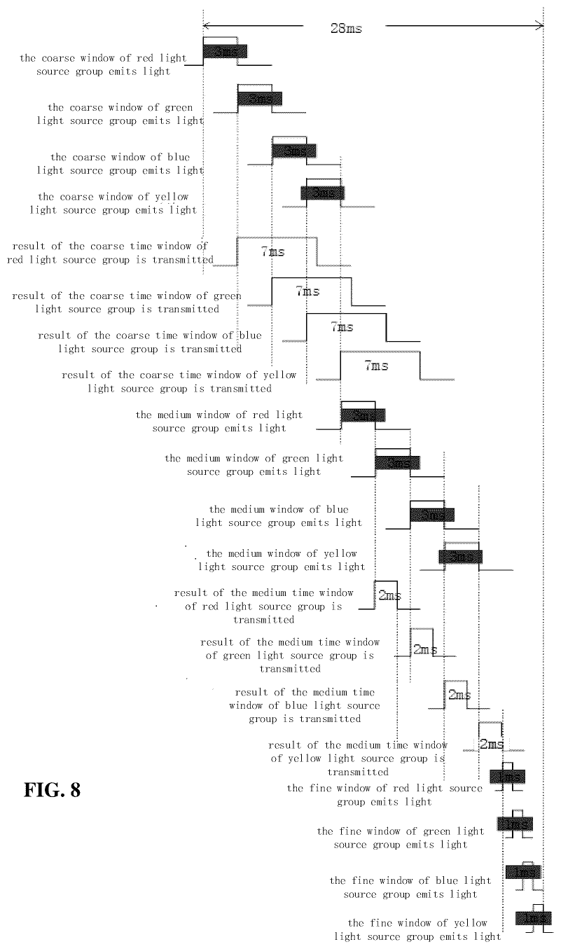

FIG. 8 is diagram showing another detailed exploded view of a system operation sequence control of the according to an embodiment of the present disclosure, as shown in FIG. 8 the emitting group light source is divided into 4, and it can be clearly seen from FIG. 8 that the serial operation of the emission light and the parallel operation of the processing circuit (based on the high-resolution scheme of the coarse, medium, and fine time windows associated with time series, actually can only include two or more different time windows, which is not limited here), the 4 light emitting groups are identified as red light source group, green light source group, blue light source group, and yellow light source group, corresponding to E1, E2, E3, and E4 shown in FIG. 5 respectively. The clock triggers to start the emission time of the coarse time window to obtain the statistical results, the red light source group continues to emit for a period of time to achieve a predetermined number of pulse laser emission times, the green light source group is emitted after the first time interval from the red light source group emitting pulse laser (shown in FIG. 8 is 3 ms), and the green light source group continues for a predetermined time (shown in FIG. 8 is 3 ms), E2 finishes emitting a predetermined number of pulse laser. Similarly, blue light source group and yellow light source group are sequentially triggered according to the emission sequence after the first time interval. The emission time of the four light source groups has a first timing correlation. And the 4 light source groups do not overlap in the emitting timing, as mentioned previously the receiving end needs to be divided and received serially, but the data processing can be parallel. Arrange at least partially overlapping red light source group E1 in the coarse time window emission light triggered sequence of the green light source group E2, that is, the statistical result of the coarse time window of E1 is transmitted, the histogram operation and transmission timing are also serialized to avoid to increase the number of storage units and arithmetic units, that is, the fine time window emitting sequence of E1 of red light source is triggered only after the longer of the transmission timing of the statistical results of the coarse time window of E1 and the emitting sequence of the green light source group of E2 is over, that is the E1 emitting group emits a predetermined amount of emission light, and the statistics of the middle time window are performed, of course, he emission light duration of the middle time window can be the same as the emission light duration of the coarse time window, that is, the emitting time interval of the first timing correlation equals to the emitting time interval of the second timing correlation. In this way, the efficiency of calculation and processing can be ensured to ensure the accuracy of positioning. Therefore, the emission light of the middle time window of the E2 emitting light group also has the same first timing correlation as the coarse time window, and the data transmission sequence arrangement of the middle time window is similar to the coarse time window, and will not be described in detail here. To obtain more accurate detection results, fine time windows is required as supplementary, however, in order to ensure the efficiency of the ranging system, the duration of the emission light in the fine time window is optimally smaller than the duration of the emission light in the coarse and/or medium time windows, that is the number of pulses is also small in the fine time window, under this design idea the fine time window triggering of the red light source group E1 can be arranged to start at any time of the period of the data transmission time window of E2, and is optimally included in the duration which the data transmission time of the medium time window of E2. Further there is a third time interval between emission light of the fine time window (that is, between the emission light of fine time window of E1, E2, E3, E4), that is, the third timing correlation within the group, optimally, the time interval of the third timing association is smaller than the time interval of the first timing association, and also smaller than the time interval of the second timing association, the efficient utilization of the entire processing circuit, and there is no increase in space can be achieved by the methods. Here, the red light source group E1 and the green light source group E2 are mainly used as examples to describe the emitting light sources are serial in time but the output transmission is parallel in time in detail, the specific timing of the blue light source group E3 and the yellow light source group E4 are similarly, as shown in FIG. 8, details are not described here.

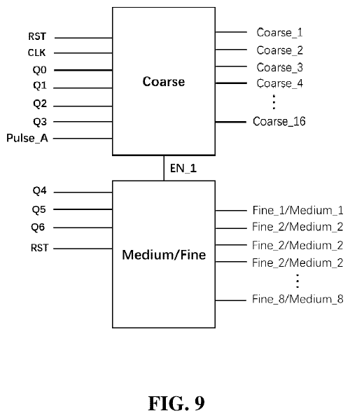

FIG. 9 is a schematic diagram showing storage design under a coarse, medium and fine time window design, wherein the coarse time window adopts a 4-bit structure, and the middle time windows and fine time windows adopt a 3-bit structure, and because statistics of the middle time windows and fine time windows are designed to be the same bit, the structure can therefore be designed as the same common module, so the common module can referenced in a finer more pattern detection design, then the higher accuracy without changing the basic structure can be achieved, the structure can therefore realize the output of 16 statistical windows related to the flight time within the detected distance range because the coarse time window adopts a 4-bit structure, in the same principle, the output of 8 statistical windows related to the flight time within the detected distance range in the middle time windows and fine time windows, of course, more bit structures can be included in actual use, and this is only an exemplary description, and does not limit the specific implementation.

The above-mentioned design of the present disclosure can meet the requirements of system integration and miniaturization, and design the acquisition frequency of the distance information for the detected object in the field of view according to the resolution standard of the human eye in the state of high concentration, the requirements of high resolution and the requirements of ranging scope can be achieved, and ensures the reliability and safety of the entire system.

It should be noted that the terms “including”, “comprising” or any other variation thereof are intended to encompass a non-exclusive inclusion such that a process, method, article or device comprising a series of elements includes not only those elements, but also no other elements expressly listed, or which are also inherent to such a process, method, article or apparatus. Without further limitation, an element qualified by the phrase “comprising a . . . ” does not preclude the presence of additional identical elements in a process, method, article or apparatus that includes the element.

The above descriptions are only preferred embodiments of the present disclosure, and are not intended to limit the present application. For those skilled in the art, the present disclosure may have various modifications and changes. Any modification, equivalent replacement, improvement, etc. made within the spirit and principle of this application shall be included within the protection scope of this application. It should be noted that like numerals and letters refer to like items in the following figures, so once an item is defined in one figure, it does not require further definition and explanation in subsequent figures. The above descriptions are only preferred embodiments of the present disclosure, and are not intended to limit the present application. For those skilled in the art, the present application may have various modifications and changes. Any modification, equivalent replacement, improvement, etc. made within the spirit and principle of this application shall be included within the protection scope of this application.

1. A distance information acquisition system, include: a light source module, a receiving module and a processing module; the light source module includes N groups of emission light with timing correlation, where N is an integer greater than or equal to 3, and at least two groups of adjacent emission light include timing correlation in emission timing; the receiving module receives the returned light of N groups of emission light in the field of view and converts the returned light signal into electrical signal, where the N groups of emission light are emitted by the light source module; and the processing module obtains a set of distance information of the detected object in the complete field of view according to the electrical signals converted by the N groups of emission light.

2. The distance information acquisition system according to claim 1, wherein the N groups of emission light are at least divided into M emitting types of light, where M is an integer greater than or equal to 2, wherein there are at least 2 groups of emission light in at least one type of light, the at least 2 groups of emission light includes a first timing correlation in emission timing, the M emitting types of light include a second timing correlation in emission timing.

3. The distance information acquisition system according to claim 1, wherein the N is 4 of the N groups of emission light with timing correlation.

4. The distance information acquisition system according to claim 2, wherein the light emission time interval of the first timing correlation is less than or equal to the light emission time interval of the second timing correlation.

5. The distance information acquisition system according to claim 2, wherein the light emission time interval of the first timing correlation further includes a quench time interval where the quench time interval is not more than 20% of the minimum duration of the N groups of emission light.

6. The distance information acquisition system according to claim 1, wherein the N groups of emission light with time correlation are all emission light spot clusters, where each spot cluster includes the same number of multiple discontinuous light spots.

7. The distance information acquisition system according to claim 1, wherein the receiving module includes SPAD array module.

8. The distance information acquisition system according to claim 7, wherein the processing module obtains at least two different time windows widths statistical results according to at least one group of emission light conversion signals output by the SPAD array module.

9. The distance information acquisition system according to claim 8, wherein the processing module obtains the distance result information of the detected object in the field of view according to the at least two different time windows widths statistical results of the at least one group of emission light conversion signals.

10. The distance information acquisition system according to claim 1, wherein the distance information acquisition system acquires not less than 30 groups distance information of the detected objects in a complete field of view, during at least part of the working time.

11. The distance information acquisition system according to claim 2, wherein at least two groups of emission light of at least one emitting type further include a third timing correlation in the emission timing.

12. The distance information acquisition system according to claim 11, wherein the light emission time interval of the third timing correlation is less than the light emission time interval of the first timing correlation.
